(19) United States
(12) Patent Application Publication
(10) Pub. No.: US 2026/0149189 A1
(43) Pub. Date: May 28, 2026

(54) ANTENNAS HAVING SELECTIVE MATERIAL LOADING

(71) Applicant: The Boeing Company, Arlington, VA (US)

(72) Inventor: Stephen Jiebang Young, Seattle, WA (US)

(21) Appl. No.: 18/958,772

(22) Filed: Nov. 25, 2024

(51) Int. Cl. H01Q 25/00; H01Q 21/24

(52) U.S. Cl. CPC H01Q 25/001; H01Q 21/24

(57) ABSTRACT

Antennas having selective material loading are disclosed. An example antenna includes a ground plane, a radiator layer, and a loading layer including discrete loading portions located adjacent to the periphery of the radiator layer.

### FIELD OF THE DISCLOSURE

This disclosure relates generally to antennas and, more particularly, to antennas having selective material loading.

### BACKGROUND

Antennas are used in a wide range of applications today. Antennas enable communication, navigation, sensing, monitoring, radio and more.

### SUMMARY

An example antenna includes a ground plane, a radiator layer, and a loading layer including discrete loading portions located adjacent to the periphery of the radiator layer.

Another example apparatus includes an antenna including a ground plane, circumferentially spaced loading portions opposite the ground plane, and a sinuous radiator adjacent to the loading portions.

Yet another example apparatus includes an antenna including a ground plane, a radiator layer, and a loading layer between the radiator layer and the ground plane, the loading layer including a plurality of discrete loading portions distributed about the loading layer.

### BRIEF DESCRIPTION OF THE DRAWINGS

FIG. 1 shows a perspective view of an example antenna constructed in accordance with the teachings herein.

FIG. 2 shows a side view of the antenna of FIG. 1.

FIG. 3 shows a top view of the antenna of FIG. 1.

### DETAILED DESCRIPTION

Some antenna applications that require lower frequency radiation and sensing require an antenna to be relatively thick and large in diameter. For example, sinuous antennas have an outer radius that is dictated by the lowest frequency of the operating band. Low-frequency ultra-wideband sinuous antennas are therefore physically large (e.g., a few feet in diameter). Also, the sinuous radiator must be placed at a significant fraction of a wavelength above the ground plane so that the radiator can radiate and sense efficiently while maintaining polarity.

To make low frequency antennas more compact, the antenna may be loaded with loading materials. As used herein the terms “loading” and “loaded” refer to an electrical, magnetic and/or magnetodielectric load that affects the electromagnetic signal frequency response of the antenna. The reduced size of the antenna allows for the antenna to be integrated into other systems where space is limited. One known solution to reduce the diameter of an antenna is to load the entire antenna radiator(s) with a substrate having a high dielectric constant (e.g., a high-k substrate). However, loading an antenna for use in low frequency applications, which are large antennas that require a large amount of loading, with a high-k substrate material can make the antenna too heavy for certain applications. Additionally, loading over the entire area of the antenna introduces significant electrical losses in the system, particularly at higher operating band of the antenna. Another known approach to reduce the diameter of an antenna is Z-plane meandering which, in combination with a substrate profile, reduces the overall diameter of the radiator. However, this technique introduces similar issues described above regarding weight and electrical losses.

Existing solutions to make antennas low-profile include loading the antenna with absorptive and ferrite materials. Absorptive materials can include carbon-doped honeycomb or foam. These materials are placed between the ground plane and the radiator of the antenna. The absorptive material dissipates the radiated waves towards the ground plane and results in loss of radiation efficiency. Loading with ferrite materials typically involves a complete loading of ferrite materials adjacent to the radiator. However, ferrite material can be heavy, making this method unsuitable in certain applications.

Typically, different areas of an antenna radiator are responsible for different frequencies. The areas of the radiator radiating and sensing high frequency signals do not benefit from loading. In fact, loading these areas decreases the overall performance of the antenna by introducing electrical losses. Examples disclosed herein provide a different approach for loading antennas that enable antennas to be low-profile and compact while also minimizing electrical losses and weight. Examples disclosed herein employ a loading technique that includes selectively applying loading material in different regions of the antenna responsible for radiating and sensing signals at specific frequencies.

The technique disclosed herein selectively loads an antenna with magnetic and magnetodielectric materials to alter the frequency response of the antenna. An antenna radiator radiates and senses different frequencies in different regions of the radiator. For example, an antenna may radiate and sense low frequency signals on the periphery of the radiator. Loading these low frequency radiating and sensing areas of the radiator allows for a better frequency response. It also enables the antenna to be more compact and low-profile. Antennas used in certain applications, such as aviation, also require that the antenna be relatively low weight. The disclosed selective loading technique enables antennas to be optimized for specific applications. Some applications may have a high sensitivity to weight, while others may prioritize the antenna being compact and low-profile. Using the examples disclosed herein provides for a high level of configurability to enable antenna designers to meet application specific needs.

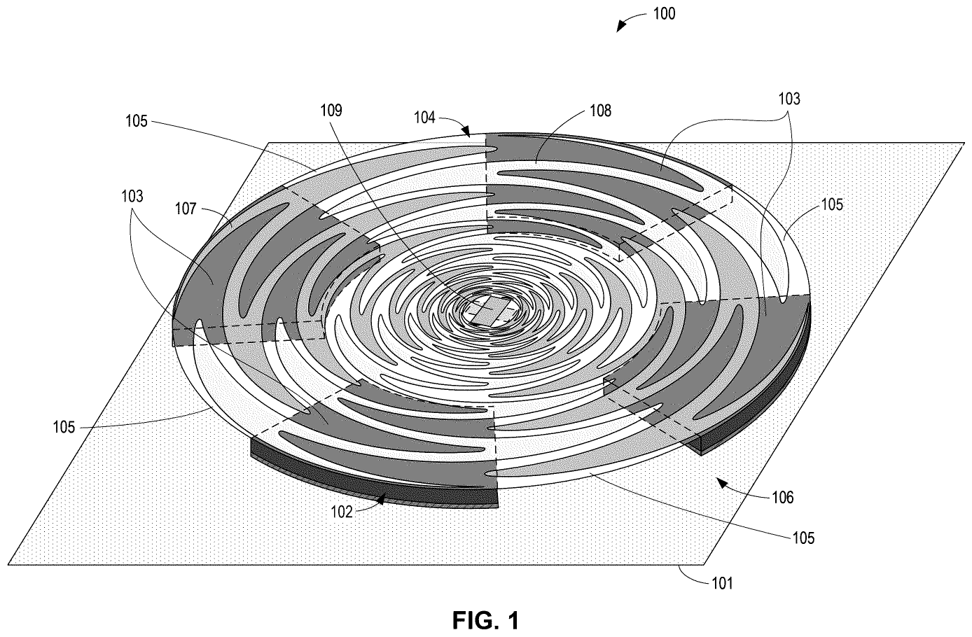

For purposes of illustration, the examples presented are described with specific dimensions. However, other dimensions may be used to suit the needs of a particular application. FIG. 1. is a perspective view of an example ultrawideband dual-polarized sinuous antenna 100 disclosed herein. In the illustrated example, the antenna 100 includes a ground plane 101, a loading layer 102 including four loading portions 103 located adjacent to the periphery of a radiator layer 104 separated by four non-loading portions 105, an electrically insulating layer 106, and the radiator layer 104. In the illustrated example, the loading layer 102 and radiator layer 104 have a generally circular shape having a first section defining a first quadrant with a first loading portion 103 and a second section defining a second quadrant with a second loading portion 103. The radiator layer 104 includes two horizontally polarized sinuous radiators 107 and two vertically polarized sinuous radiators 108. The vertically polarized sinuous radiators 108 and the horizontally polarized sinuous radiators 107 originate from the center of the radiator layer 104 and extend outward to the periphery of the radiator layer 104, one in each quadrant of the radiator layer 104. Similarly polarized radiators (e.g., horizontally polarized) originate one hundred and eighty degrees from each other, and ninety degrees from opposite polarized radiators (e.g., vertically polarized, and horizontally polarized). The radiator layer 104 is located opposite the ground plane 101. In the illustrated example, the radiator layer 104 is depicted as transparent to show the underlying loading portions 103 and non-loading portions 105. The antenna 100 also includes excitation ports 109 for the horizontally polarized sinuous radiators 107 and the vertically polarized sinuous radiators 108.

The example antenna 100 is configured to operate in the very high frequency (VHF) range. In one example, the antenna 100 achieves a 45-inch diameter and a thickness of 4 inches. In comparison, an unloaded antenna would be about 35 percent larger and thicker to achieve a similar gain in the VHF range. The example antenna 100 also achieves a 40 percent weight savings compared to a fully loaded sinuous antenna operating in the VHF range. In some examples, the loading layer 102 may include other numbers of loading portions 103 and non-loading portions 105 (e.g., 1, 2, 3, 5, etc.). In some examples, the antenna 100 may be configured to operate in different frequency ranges (ultra-high frequency range, super high frequency range, extremely high frequency range, etc.). In some examples, other planar antennas may be used (e.g., log-periodic antennas, bowtie antennas, spiral antennas, patch antennas, etc.).

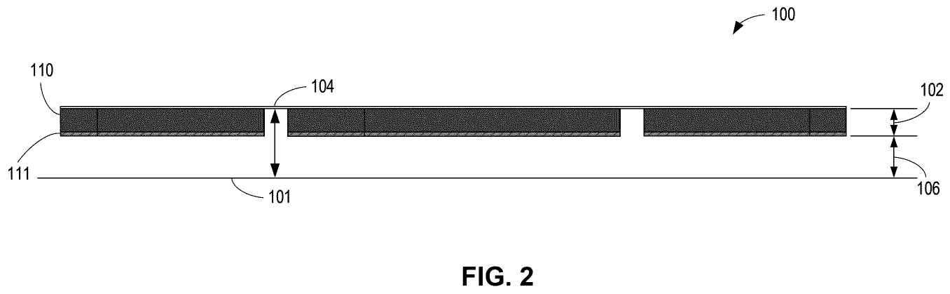

FIG. 2. is a side view of the example antenna 100 of FIG. 1. In the illustrated example the radiator layer 104 is separated from the ground plane 101 by the loading layer 102 and the insulating layer 106. In the illustrated example, the insulating layer 106 is filled with air. In other examples, the insulation layer may include other non-conductive materials such as absorptive materials (e.g., carbon-doped honeycomb, foam, etc.). In the illustrated example, the distance between the radiator layer 104 and the ground plane 101 is 4 inches, with the loading portions 103 being about 1.5 inches thick. However, any other dimensions may be used to suit the needs of a particular application. The loading layer 102 is adjacent to the radiator layer 104 and is separated from the ground plane 101 by the electrically insulating layer 106. In some examples, the electrically insulating layer 106 may be omitted. In some examples, the loading portions 103 of the loading layer 102 may include a magnetodielectric sub-layer 110 and a ferrite material sub-layer 111. In other examples, the loading portions 103 of the loading layer 102 may include a composite of magnetodielectric and ferrite materials, or other materials or combination of materials suitable for loading a planar antenna.

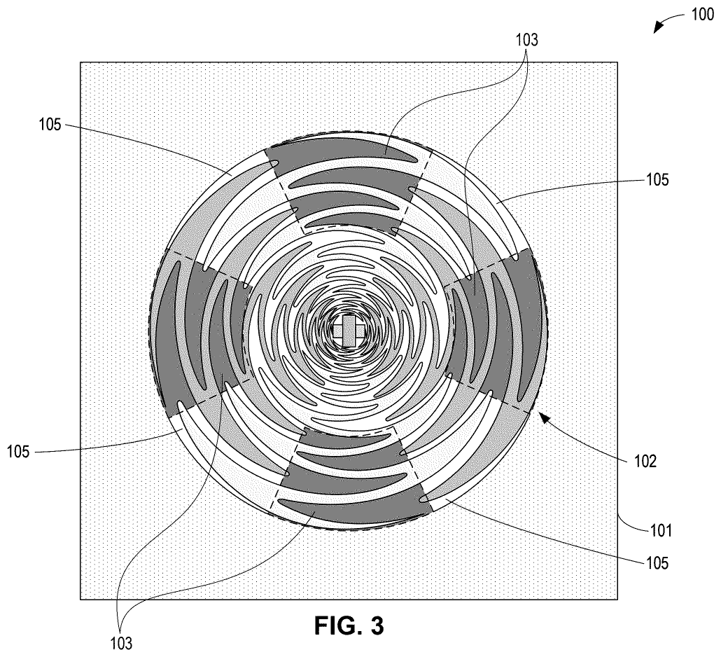

FIG. 3. is a top view of the example antenna 100 of FIG. 1. In the illustrated example, the loading layer 102 illustrates four loading portions 103 located adjacent to the periphery of the radiator layer 104 and separated by the non-loading portions 105. In some examples, the antenna 100 may include a plurality of circumferentially spaced loading portions 103 opposite the ground plane 101 and a radiator adjacent to the loading portions 103. For example, instead of four loading portions 103 as illustrated in FIG. 3, the antenna 100 includes more than four loading portions 103, where each is circumferentially spaced, as illustrated in FIG. 1.

In some examples, the loading layer 102 may have a first surface area that is less than a second surface area of the radiator layer 104. For example, the periphery of the antenna 100 represents the first surface area, while the second surface area of the radiator includes the entire surface area of the radiator layer 104. In some examples, the antenna 100 includes a distribution of loading portions 103 and non-loading portions 105 arranged radially in the loading layer 102. For example, instead of the four loading portions 103 and four non-loading portions 105 as illustrated in FIG. 3, the antenna 100 includes more than four loading portions 103 and more than four non-loading portions 105 arranged radially in the loading layer 102. In some examples, the loading layer 102 includes a plurality of discrete loading portions 103 distributed about the loading layer 102. Arranging the loading portions 103 in different patterns or having different numbers of loading portions 103 can have a large affect on frequency response. In some examples, antennas may have a different number of loading portions than in the illustrated example to optimize the antenna for specific applications. For example, an antenna prioritizing overall size may have many large loading portions 103, while an antenna prioritizing weight may have fewer and smaller loading portions 103.

Arranging the loading portions adjacent to the section of radiator that radiates and senses low frequency signals enables an antenna to be compact and low-profile while optimizing for efficiency. In some examples, the antenna 100 may include loading portions 103 located adjacent to a peripheral portion of the radiator layer 104. In some examples, the loading layer 102 includes a non-loading portion 105 adjacent to a section of the radiator layer 104 that radiates and senses low frequency signals in the very high frequency band. In some examples, the loading portions 103 are spaced from a central portion of the loading layer 102.

The foregoing description of the specific embodiments will so fully reveal the general nature of the present disclosure that others can, by applying knowledge within the skill of the art, readily modify and/or adapt, for various applications, such specific embodiments, without undue experimentation, and without departing from the general concept of the present disclosure. Therefore, such adaptations and modifications are intended to be within the meaning and range of equivalents of the disclosed embodiments, based on the disclosure and guidance presented herein. It is to be understood that the phraseology or terminology herein is for the purpose of description and not of limitation, such that the terminology or phraseology of the present specification is to be interpreted by the skilled artisan in light of the disclosure and guidance.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

From the foregoing, it will be appreciated that example systems, apparatus, articles of manufacture, and methods have been disclosed that enable antennas to be more compact and low-profile through selective electrical loading. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

Example methods, apparatus, systems, and articles of manufacture to selectively load antennas are disclosed herein. Further examples and combinations thereof include the following.

Example 1 includes an antenna including a ground plane, a radiator layer, and a loading layer including discrete loading portions located adjacent to a periphery of the radiator layer.

Example 2 includes the antenna of example 1, wherein the antenna is configured to operate in the very high frequency range.

Example 3 includes the antenna of example 1, wherein the loading layer includes a non-loading portion between the loading portions.

Example 4 includes the antenna of example 1, wherein the loading portions are radially arranged in the loading layer.

Example 5 includes the antenna of example 1, wherein the loading layer has a first surface area that is less than a second surface area of the radiator layer.

Example 6 includes the antenna of example 1, wherein the loading layer has a generally circular shape having a first section defining a first quadrant with a first loading portion and a section defining a second quadrant with a second loading portion.

Example 7 includes the antenna of example 1, wherein the loading layer includes a ferrite material and a magnetodielectric material.

Example 8 includes an antenna including a ground plane, circumferentially spaced loading portions opposite the ground plane, and a radiator adjacent to the loading portions.

Example 9 includes the antenna of example 8, wherein the antenna is configured to operate in the very high frequency range.

Example 10 includes the antenna of example 8, wherein the loading portions include a ferrite material and a magnetodielectric material.

Example 11 includes the antenna of example 8, wherein the loading portions are electrically insulated from the ground plane.

Example 12 includes the antenna of example 8, wherein the loading portions are located adjacent to a peripheral portion of the radiator.

Example 13 includes the antenna of example 8, wherein the loading portions are separated by a non-loading portion.

Example 14 includes an antenna including a ground plane, a radiator layer, and a loading layer between the radiator layer and the ground plane, the loading layer including a plurality of discrete loading portions distributed about the loading layer.

Example 15 includes the antenna of example 14, wherein the antenna is configured to operate in the very high frequency range.

Example 16 includes the antenna of example 14, wherein the loading portions include a ferrite material and a magnetodielectric material.

Example 17 includes the antenna of example 14, wherein a first loading portion is separated from a second loading portion by a non-loading portion.

Example 18 includes the antenna of example 14, wherein the loading portions are spaced from a central portion of the loading layer.

Example 19 includes the antenna of example 14, wherein the loading layer includes a non-loading portion adjacent to a section of the radiator layer that radiates low frequency signals in the very high frequency range.

Example 20 includes the antenna of example 14, wherein the loading layer is separated from the ground plane by an electrically insulating layer.

What is claimed is:

1. An antenna comprising:
a ground plane;
a radiator layer; and
a loading layer including discrete loading portions located adjacent to a periphery of the radiator layer.

2. The antenna of claim 1, wherein the antenna is configured to operate in the very high frequency range.

3. The antenna of claim 1, wherein the loading layer includes a non-loading portion between the loading portions.

4. The antenna of claim 3, wherein the loading portions are radially arranged in the loading layer.

5. The antenna of claim 1, wherein the loading layer has a first surface area that is less than a second surface area of the radiator layer.

6. The antenna of claim 5, wherein the loading layer has a generally circular shape having a first section defining a first quadrant with a first loading portion and a second section defining a second quadrant with a second loading portion.

7. The antenna of claim 1, wherein the loading layer includes a ferrite material and a magnetodielectric material.

8. An antenna comprising:
a ground plane;
circumferentially spaced loading portions opposite the ground plane; and
a radiator adjacent to the loading portions.

9. The antenna of claim 8, wherein the antenna is configured to operate in the very high frequency range.

10. The antenna of claim 8, wherein the loading portions include a ferrite material and a magnetodielectric material.

11. The antenna of claim 8, wherein the loading portions are electrically insulated from the ground plane.

12. The antenna of claim 8, wherein the loading portions are located adjacent to a peripheral portion of the radiator.

13. The antenna of claim 8, wherein the loading portions are separated by a non-loading portion.

14. An antenna comprising:
a ground plane;
a radiator layer; and
a loading layer between the radiator layer and the ground plane, the loading layer including a plurality of discrete loading portions distributed about the loading layer.

15. The antenna of claim 14, wherein the antenna is configured to operate in the very high frequency range.

16. The antenna of claim 14, wherein the loading portions include a ferrite material and a magnetodielectric material.

17. The antenna of claim 14, wherein a first loading portion is separated from a second loading portion by a non-loading portion.

18. The antenna of claim 14, wherein the loading portions are spaced from a central portion of the loading layer.

19. The antenna of claim 18, wherein the loading layer includes a non-loading portion adjacent to a section of the radiator layer that radiates low frequency signals in the very high frequency range.

20. The antenna of claim 14, wherein the loading layer is separated from the ground plane by an electrically insulating layer.
